(19) United States
(12) Patent Application Publication
(10) Pub. No.: US 2024/0326563 A1
(43) Pub. Date: Oct. 3, 2024

(54) WIND DIRECTION ADJUSTMENT APPARATUS

(71) Applicant: NIHON PLAST CO., LTD., Fujinomiya-shi (JP)

(72) Inventor: Muneharu Sano, Shizuoka (JP)

(21) Appl. No.: 18/604,549

(22) Filed: Mar. 14, 2024

(30) Foreign Application Priority Data
Mar. 28, 2023 (JP) 2023-051187

(51) Int. Cl. B60H 1/34

(52) U.S. Cl. CPC B60H 1/3421; B60H 2001/3471

(57) ABSTRACT

Provided is a wind direction adjustment apparatus that can stabilize an operational feeling of a louver. The wind direction adjustment apparatus includes a plurality of downstream side louvers disposed in a ventilation path, a link that causes downstream side louvers to pivot in conjunction with each other, and a joining section forming an adjustment section that adjusts a pressing force for pressing one of at least one of the downstream side louvers and the link against the other.

### CROSS REFERENCE TO RELATED APPLICATIONS

This application is entitled to and claims the benefit of Japanese Patent Application No. 2023-051187 filed on Mar. 28, 2023, the disclosure of which including the specification, drawings and abstract is incorporated herein by reference in its entirety.

### TECHNICAL FIELD

The present invention relates to a wind direction adjustment apparatus including a link through which a plurality of louvers pivot in conjunction with each other.

### BACKGROUND ART

Conventionally, in an air conditioner used in a vehicle such as an automobile, a wind direction adjustment apparatus that adjusts a blowing wind direction is known. The wind direction adjustment apparatus is also called an air conditioning wind blowing apparatus, an air outlet, a ventilator, or a register. For example, the wind direction adjustment apparatus is installed in various components of the vehicle, such as an instrument panel and a center console section, and contributes to improvement in comfort performance achieved by cooling and heating.

In this wind direction adjustment apparatus, the following method is known. A bearing hole that supports a pivoting shaft of a louver which pivots to adjust the wind direction is formed by using a soft spacer, and a pivoting torque of the louver is set by sliding resistance between the pivoting shaft and the bearing hole. In this manner, an operation load of the louver is stabilized (for example, refer to PTL 1).

### CITATION LIST

### Patent Literature

### PTL 1

Japanese Patent Application Laid-Open No. 2022-25551 (pages 4 to 9, FIGS. 2 to 6)

### SUMMARY OF INVENTION

### Technical Problem

However, in a case of the above-described configuration, there is a limit in adjusting the operation load of the louver. Therefore, for example, it is desirable that the operation load can be adjusted even after product assembly.

The present invention is made in view of the above-described circumstances, and an object of the present invention is to provide a wind direction adjustment apparatus that can stabilize an operational feeling of a louver.

### Solution to Problem

A wind direction adjustment apparatus according to a first aspect includes a plurality of louvers disposed in a ventilation path, a link that causes the louvers to pivot in conjunction with each other, and an adjustment section that adjusts a pressing force for pressing one of at least one of the louvers and the link against the other.

As the wind direction adjustment apparatus according to a second aspect, in the wind direction adjustment apparatus according to the first aspect, the adjustment section may include a clamping target section formed in one of at least one of the louvers and the link, a clamping section formed in the other of at least one of the louvers and the link to clamp the clamping target section, and an adjustment member fastened across the clamping target section and the clamping section to adjust a clamping force of the clamping section against the clamping target section.

As the wind direction adjustment apparatus according to a third aspect, the wind direction adjustment apparatus according to the second aspect may include joining sections that pivotably join each louver and the link, in which at least one of the joining sections may form an adjustment section.

As the wind direction adjustment apparatus according to a fourth aspect, the wind direction adjustment apparatus according to the third aspect may include a case body that internally defines the ventilation path, in which the case body may have a through-hole that communicates with the ventilation path to enable a fastening amount to be adjusted from an outside by the adjustment member.

### Advantageous Effects of Invention

According to the wind direction adjustment apparatus in the first aspect, variations in an operation load which are caused by an individual difference between components can be suppressed with a simple configuration, and an operational feeling can be stabilized.

According to the wind direction adjustment apparatus in the second aspect, in addition to an advantageous effect of the wind direction adjustment apparatus according to the first aspect, it is possible to adopt a simple configuration which can easily adjust the clamping force of the clamping section against the clamping target section by adjusting a fastening amount of the adjustment member.

According to the wind direction adjustment apparatus in the third aspect, in addition to an advantageous effect of the wind direction adjustment apparatus according to the second aspect, at least one of the joining sections that pivotably join the respective louvers and the link is used as the joining section forming the adjustment section. In this manner, the other remaining joining sections can be operated in conjunction with each other with the operation load set by the adjustment section. Therefore, the number of the adjustment sections can be reduced to a minimum requirement, and a configuration can be simplified.

According to the wind direction adjustment apparatus in the fourth aspect, in addition to an advantageous effect of the wind direction adjustment apparatus according to the third aspect, even after the wind direction adjustment apparatus is assembled, the operation load of the louver can be easily adjusted by the adjustment member from the outside of the case body, and ventilation inside the ventilation path is not hindered by the adjustment member.

### BRIEF DESCRIPTION OF DRAWINGS

FIG. 1 is a sectional view illustrating a wind direction adjustment apparatus according to an embodiment of the present invention;

FIG. 2 is an exploded perspective view illustrating a joining section of the wind direction adjustment apparatus;

FIG. 3 is a perspective view illustrating the wind direction adjustment apparatus; and

FIG. 4 is an exploded perspective view illustrating a joining section of a wind direction adjustment apparatus according to another embodiment of the present invention.

### DESCRIPTION OF EMBODIMENTS

Hereinafter, an embodiment of the present invention will be described with reference to the drawings.

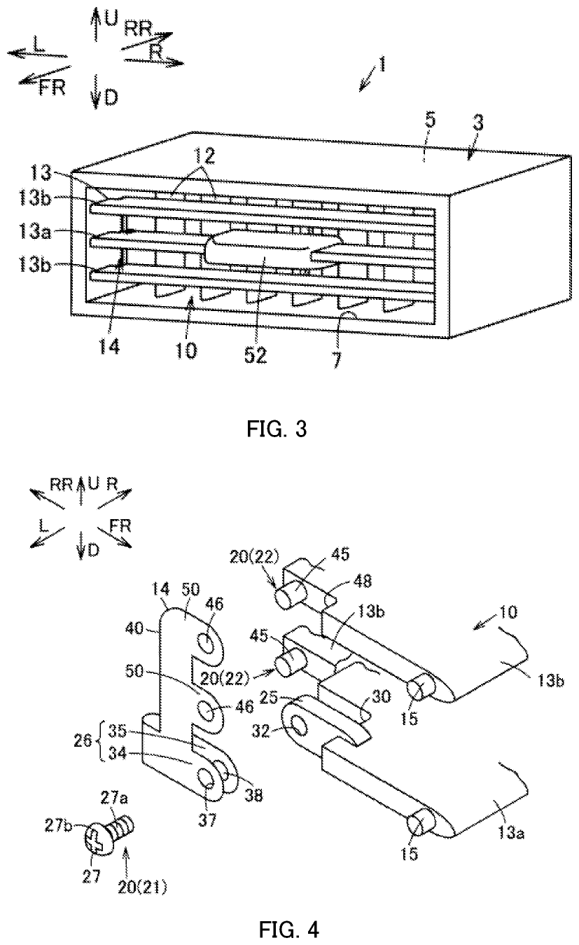

In FIG. 3, reference number 1 represents a wind direction adjustment apparatus. Wind direction adjustment apparatus 1 is also called an air outlet, a ventilator, or a register, and adjusts a wind blowing direction from an air conditioner. Hereinafter, for more clear description, in the wind direction adjustment apparatus 1, a leeward side from which wind blows will be defined as a front side, a front surface side, or a near side. A side opposite thereto, that is, a windward side which receives the wind will be defined as a rear side, a back side, or a far side. In this manner, a both side direction or a width direction which is a rightward-leftward direction when viewed from the front side, and an upward-downward direction will be defined. In the present embodiment, wind direction adjustment apparatus 1 is applied to an air conditioner for a vehicle such as an automobile. Wind direction adjustment apparatus 1 may be disposed at any desired position. In the drawings, arrow FR side will be defined as the front side, arrow RR side will be defined as the rear side, arrow L side will be defined as a left side, arrow R side will be defined as a right side, arrow U side will be defined as an upper side, and arrow D side will be defined as a lower side. The directions are illustrated only as examples, and may be changed as appropriate depending on an installation position or an installation orientation of wind direction adjustment apparatus 1.

Wind direction adjustment apparatus 1 includes case body 3. Case body 3 is also called a duct. For example, case body 3 is formed of a synthetic resin in a cylindrical shape. In the present embodiment, case body 3 is formed in the cylindrical shape in a forward-rearward direction. In the illustrated example, case body 3 is formed in a rectangular cylindrical shape. In the present embodiment, for example, case body 3 is formed in a horizontally long shape. Ventilation path 5 is internally surrounded by case body 3. A direction parallel to a central axis of case body 3 is a ventilation direction of ventilation path 5. In the present embodiment, the ventilation direction of ventilation path 5 is the forward-rearward direction, and ventilation is performed from the rear side to the front side. That is, in ventilation path 5, the rear side is an upstream side in the ventilation direction, and the front side is a downstream side in the ventilation direction.

A receiving port through which ventilation path 5 receives air, that is, air conditioning wind, is formed in a rear end portion of case body 3, and air outlet 7 through which the air conditioning wind is discharged from the ventilation path 5 is formed in a front end portion of case body 3. Ventilation path 5 allowing communication is formed between the receiving port and air outlet 7. The air conditioning wind passes from the receiving port to air outlet 7. The receiving port and air outlet 7 respectively have a horizontally long shape. Case body 3 may be integrally formed, or may be formed by combining a plurality of members. For example, case body 3 may include a main body section having the receiving port and forming a majority of case body 3, and a finisher having air outlet 7 and forming a design surface after being attached to a front end portion of the main body section.

Louver 10 is disposed inside case body 3, that is, in ventilation path 5. Louver 10 is also called a fin, and pivots with respect to case body 3, thereby adjusting a wind direction of the air conditioning wind blowing from air outlet 7 in accordance with a pivoting operation thereof. Louver 10 is formed in a plate shape in which one main surface and the other main surface serve as flow straightening surfaces.

In the present embodiment, in louver 10, upstream side louver 12 and downstream side louver 13 are set. Upstream side louver 12 is located apart behind downstream side louver 13 in ventilation path 5. Downstream side louver 13 is located to face air outlet 7. Upstream side louver 12 and downstream side louver 13 may be respectively provided in a single form or in a plurality of forms. For example, many upstream side louvers 12 are set, and three downstream side louvers 13 are set.

In the illustrated example, upstream side louvers 12 are aligned in a longitudinal direction of case body 3 or ventilation path 5, which is the rightward-leftward direction in the present embodiment, and pivot in the rightward-leftward direction which is the longitudinal direction of case body 3 or ventilation path 5. In this manner, a wind direction is adjusted in the rightward-leftward direction which is the longitudinal direction of case body 3 or ventilation path 5. Upstream side louvers 12 are joined to each other via a link, and pivot in conjunction with each other in the same direction.

In addition, downstream side louvers 13 are aligned in a short direction of case body 3 or ventilation path 5, which is the upward-downward direction in the present embodiment, and pivot in the upward-downward direction which is the short direction of case body 3 or ventilation path 5. In this manner, the wind direction is adjusted in the upward-downward direction which is the short direction of case body 3 or ventilation path 5. Downstream side louvers 13 are joined to each other via link 14, and pivot in conjunction with each other in the same direction.

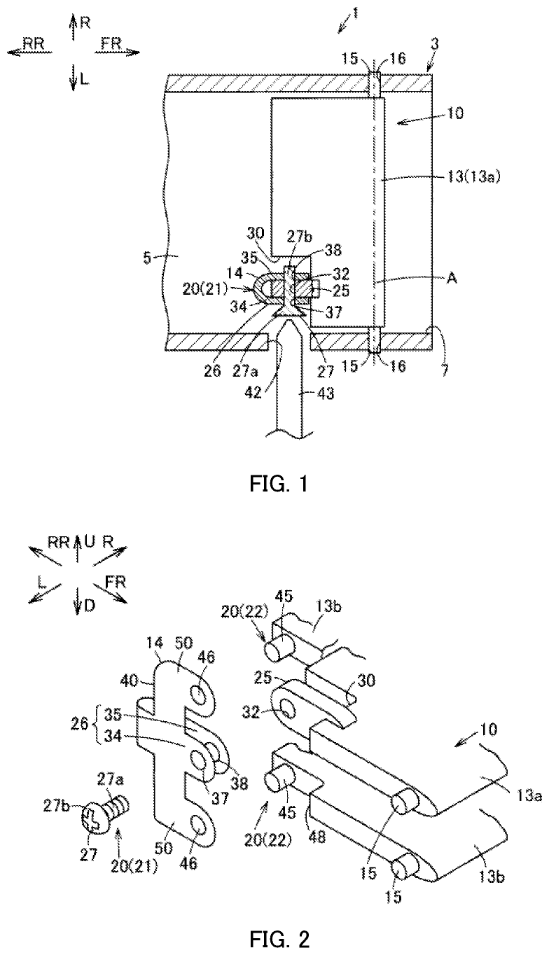

As illustrated in FIGS. 1 and 2, louver 10 has pivoting sections 15 in both end portions, and pivoting sections 15 in both end portions are pivotably supported by pivoting receiving sections 16. In this manner, louver 10 is pivotable in ventilation path 5. One of pivoting section 15 and pivoting receiving section 16 is a shaft section, and the other is a hole section or a recessed section. In the present embodiment, each of pivoting sections 15 is the shaft section, and each of pivoting receiving sections 16 is the hole section having a round hole shape or the recessed section. Both pivoting sections 15 in both end portions of louver 10 do not need to be the shaft section, the hole sections, or the recessed sections. For example, one pivoting section 15 may be the shaft section, and other pivoting section 15 may be the hole section or the recessed section. In addition, when there are a plurality of louvers 10, forms of pivoting sections 15 and corresponding pivoting receiving sections 16 of all of louvers 10 do not need to be the same.

Pivoting receiving section 16 may be formed in case body 3, or may be formed in a holding body separated from case body 3 and integrally attached to case body 3.

Each of downstream side louvers 13 and link 14 are pivotably joined to each other by joining section 20. In the present embodiment, joining section 20 is provided with one joining section 21 and other joining section 22. That is, downstream side louver 13 is provided with downstream side louver 13a joined to the link 14 by one joining section 21, and downstream side louver 13b joined to other joining section 22.

One joining section 21 is a fastening joining section including any one of downstream side louver 13a and link 14, which is clamping target section 25 formed in downstream side louver 13a in the present embodiment, the other of downstream side louver 13a and link 14 which clamping section 26 formed in link 14 in the present embodiment, and adjustment member 27 that adjusts a clamping force of clamping section 26 against clamping target section 25. One joining section 21 forms an adjustment section which adjusts a pressing force for pressing link 14 against downstream side louver 13a in such a manner that adjustment member 27 serving as a fastening member such as a screw is fastened from clamping target section 25 to clamping section 26.

Clamping target section 25 is located in one end portion of downstream side louver 13a in the longitudinal direction (direction of pivoting axis A). Clamping target section 25 is disposed in cutout section 30 formed by cutting out a corner portion of downstream side louver 13a. Cutout section 30 is located apart from pivoting section 15 in one end portion of downstream side louver 13a in the longitudinal direction. In the present embodiment, pivoting section 15 is located in a front end portion of downstream side louver 13a, and cutout section 30 is located in a rear end portion. Clamping target section 25 extends from the front to the rear in cutout section 30, that is, in a direction intersecting with or perpendicular to pivoting axis A. In clamping target section 25, insertion hole 32 into which adjustment member 27 is inserted is formed to penetrate in a direction parallel to or substantially parallel to pivoting axis A.

Clamping section 26 is configured to clamp clamping target section 25 in a direction along pivoting axis A of downstream side louver 13a. That is, clamping section 26 is formed in a U-shape having clamping piece 34 located on one side with respect to clamping target section 25, and clamping piece 35 located on the other side with respect to clamping target section 25. Clamping pieces 34 and 35 are located to face each other and to be separated from each other, and clamping target section 25 is clamped between clamping pieces 34 and 35. In the present embodiment, clamping piece 34 is stacked on clamping target section 25 outside downstream side louver 13a, and clamping piece 35 is stacked on clamping target section 25 inside downstream side louver 13a.

Insertion hole 37 into which adjustment member 27 is inserted is formed in clamping piece 34. In addition, clamping piece 35 has fastening hole 38 forming a female screw section to which adjustment member 27 is fastened. For example, fastening hole 38 is formed by burring clamping piece 35.

Here, link 14 in which clamping section 26 of the present embodiment is formed is made of metal, for example, and has longitudinal link main body section 40. Clamping section 26 having plate-shaped clamping pieces 34 and 35 extends forward with respect to link main body section 40.

Adjustment member 27 can adjust a clamping force of clamping section 26 against clamping target section 25 by adjusting a fastening amount between clamping target section 25 and clamping section 26. In the present embodiment, adjustment member 27 is made of metal, and has cylindrical shaft section 27a forming a male screw section and head section 27b enlarged in an end portion of shaft section 27a. Shaft section 27a is inserted from insertion hole 37 of clamping piece 34 of clamping section 26, into insertion hole 32 of clamping target section 25, and fastening hole 38 of clamping piece 35 of clamping section 26, and is fastened to fastening hole 38.

Preferably, adjustment member 27 can access head section 27b with respect to through-hole 42 formed in case body 3 from the outside of case body 3, that is, from the outside of ventilation path 5, and the fastening amount can be adjusted from the outside via through-hole 42.

Through-hole 42 penetrates case body 3 to communicate with ventilation path 5.

In the present embodiment, through-hole 42 is formed in a side surface portion of case body 3. Fastening jig 43 such as a screwdriver can be inserted into through-hole 42 from the outside of case body 3.

Other joining sections 22 include shaft section 45 formed in any one of downstream side louver 13b and link 14 and hole section 46 that pivotably receives shaft section 45 formed in the other of downstream side louver 13b and link 14. In the present embodiment, shaft section 45 is formed in downstream side louver 13b, and hole section 46 is formed in link 14.

In the illustrated example, shaft section 45 is located in one end portion of downstream side louver 13b in the longitudinal direction (direction of pivoting axis A). Shaft section 45 is disposed in cutout section 48 formed by cutting out a corner portion of downstream side louver 13b. Cutout section 48 is located apart from pivoting section 15 in one end portion of downstream side louver 13b in the longitudinal direction. In the present embodiment, pivoting section 15 is located in a front end portion of downstream side louver 13b, and cutout section 48 is located in a rear end portion. Shaft section 45 protrudes in a direction parallel to or substantially parallel to pivoting axis A in cutout section 48.

In link 14, hole section 46 is formed in extending section 50 extending forward with respect to link main body section 40. In the present embodiment, extending section 50 is located vertically apart from clamping pieces 34 and 35 of clamping section 26 of one joining section 21. That is, other joining sections 22 are set vertically in one joining section 21 in the longitudinal direction of link 14, and one joining section 21 is located in a central portion of link 14.

A joining structure of joining section 20 may be applied between upstream side louver 12 and link.

As illustrated in FIG. 3, preferably, downstream side louver 13 is provided with operation section 52 for allowing a user such as an occupant to directly operate the pivoting of louver 10. The pivoting of louver 10 can be directly operated by the user such as the occupant using operation section 52. Operation section 52 is also called an operation grip or an operation knob. In the illustrated example, operation section 52 is movable in the upward-downward direction together with downstream side louver 13, and the movement in the upward-downward direction causes downstream side louver 13 to pivot in the upward-downward direction. For example, operation section 52 may be slidable along the longitudinal direction of downstream side louver 13, and in response to the sliding, upstream side louver 12 may be operable in the rightward-leftward direction.

Furthermore, the inside case body 3, that is, ventilation path 5 may be provided with a shut valve that pivots with respect to case body 3 to open and close ventilation path 5 in response to the pivoting.

When wind direction adjustment apparatus 1 is assembled, upstream side louvers 12 are joined to each other by the link, and are integrally assembled into case body 3 from the front so that pivoting section 15 is received by pivoting receiving section 16.

In addition, downstream side louvers 13a and 13b are joined to each other by link 14. In this case, downstream side louver 13a inserts clamping target section 25 between clamping pieces 34 and 35 of clamping section 26 of link 14, inserts shaft section 27a of adjustment member 27 from insertion hole 37 of clamping piece 34 of clamping section 26 into insertion hole 32 of clamping target section 25 and fastening hole 38 of clamping piece 35 of clamping section 26, and is fastened to fastening hole 38. In addition, downstream side louver 13b inserts shaft section 45 into hole section 46 of link 14. Downstream side louvers 13a and 13b are integrally assembled into case body 3 from the front together with link 14 so that pivoting section 15 is received by pivoting receiving section 16.

In this state, while an operation load (pivoting torque) is confirmed by using operation section 52 so that louver 10 pivots, jig 43 is inserted from through-hole 42 when necessary, and the fastening amount of adjustment member 27 is adjusted. In this manner, a clamping force of clamping section 26 for clamping clamping target section 25, that is, a pressing force of one of link 14 and downstream side louver 13a for pressing the other is adjusted, and the operation load of downstream side louver 13 is set to a desired value. That is, when adjustment member 27 is loosened, since the clamping force of clamping section 26 for clamping clamping target section 25 is weakened, link 14 and downstream side louver 13a are likely to be relatively movable. Therefore, the operation load of downstream side louver 13 joined by link 14 becomes lighter. When adjustment member 27 is fastened, the clamping force of clamping section 26 for clamping clamping target section 25 becomes stronger so that link 14 and downstream side louver 13a are less likely to be relatively movable. Therefore, the operation load of downstream side louver 13 joined by link 14 becomes heavy.

In this way, according to the embodiment, at least one (downstream side louver 13a in the present embodiment) of the plurality of louvers 10 (downstream side louvers 13 in the present embodiment), link 14 that causes these to pivot in conjunction with each other, and the adjustment section that adjusts the pressing force for pressing one against the other are provided. In this manner, variations in the operation load which are caused by an individual difference between components can be suppressed with a simple configuration, and an operational feeling can be stabilized. That is, each wind direction adjustment apparatus 1 can be individually adjusted to have a desired operation load. Therefore, a tolerance of the operation load can be reduced. Therefore, it is possible to provide the wind direction adjustment apparatus 1 corresponding to the desired operation load of louver 10 and having lesser variation in the operation load. Since a defective rate can be significantly reduced, production efficiency is improved.

In addition, the adjustment section is configured to fasten adjustment member 27 across clamping target section 25 and clamping section 26 by causing clamping section 26 to clamp clamping target section 25. In this manner, it is possible to adopt a simple configuration which can easily adjust the clamping force of clamping section 26 against clamping target section 25 by adjusting the fastening amount of adjustment member 27, and it is possible to prevent deformation of clamping target section 25 and a defect of the adjustment section which is caused by the deformation in such a manner that clamping of clamping section 26 restricts the deformation of clamping target section 25 which results from a temperature condition, for example.

Moreover, since a screw is used as adjustment member 27, fastening of adjustment member 27 is less likely to be affected by the temperature or the like, and the operation load of louver 10 is stabilized.

Furthermore, at least one of joining sections 20 that pivotably join respective louvers 10 (downstream side louvers 13) and link 14 is used as one joining section 21 forming the adjustment section. In this manner, other remaining joining sections 20 can be operated in conjunction with each other with the operation load set by the adjustment section. Therefore, the number of the adjustment sections can be reduced to a minimum requirement, and a configuration can be simplified.

In addition, the fastening amount can be adjusted by adjustment member 27 via through-hole 42 communicating with ventilation path 5 of case body 3. Therefore, even after wind direction adjustment apparatus 1 is assembled, the operation load of louver 10 (downstream side louver 13 in the present embodiment) can be adjusted by adjustment member 27 from the outside of case body 3, and ventilation inside ventilation path 5 is not hindered by adjustment member 27.

Joining section 20 is not limited to a configuration in which one joining section 21 is located between other joining sections 22. For example, as in another embodiment illustrated in FIG. 4, even in a case of a configuration in which one joining section 21 is disposed in an end portion, for example, in a lowest portion, and other joining section 22 is disposed in the other portion, for example, above one joining section 21, the operational feeling of louver 10 (downstream side louver 13 in the present embodiment) can be stabilized.

Accordingly, the same operational effect as that in the embodiment can be achieved.

In addition, in each of the embodiments, louver 10 is configured so that upstream side louver 12 and downstream side louver 13 are set. Meanwhile, without being limited thereto, the present invention may be configured to include only louver 10 facing air outlet 7.

Furthermore, the adjustment section is configured to adjust the clamping force for clamping clamping target section 25 with clamping section 26 by fastening adjustment member 27. Meanwhile, the present invention is not limited to this configuration as long as a configuration is adopted to adjust the pressing force for pressing one of louver 10 and link 14 against the other.

Wind direction adjustment apparatus 1 is not limited to an apparatus for an automobile, and may be used for any other desired purpose.

### INDUSTRIAL APPLICABILITY

For example, the present invention can be suitably used as a wind direction adjustment apparatus for air conditioning of an automobile.

### REFERENCE SIGNS LIST

1 Wind direction adjustment apparatus
3 Case body
5 Ventilation path
13 Downstream side louver which is louver
14 Link
20 Joining section
21 One joining section forming adjustment section
25 Clamping target section
26 Clamping section
27 Adjustment member
42 Through-hole

What is claimed is:

1. A wind direction adjustment apparatus comprising:
a plurality of louvers disposed in a ventilation path;
a link that causes the louvers to pivot in conjunction with each other; and
an adjustment section that adjusts a pressing force for pressing one of at least one of the louvers and the link against the other.

2. The wind direction adjustment apparatus according to claim 1,
wherein the adjustment section includes
a clamping target section formed in one of at least one of the louvers and the link,
a clamping section formed in the other of at least one of the louvers and the link to clamp the clamping target section, and
an adjustment member fastened across the clamping target section and the clamping section to adjust a clamping force of the clamping section against the clamping target section.

3. The wind direction adjustment apparatus according to claim 2, further comprising:
joining sections that pivotably join each louver and the link,
wherein at least one of the joining sections forms an adjustment section.

4. The wind direction adjustment apparatus according to claim 3, further comprising:
a case body that internally defines the ventilation path,
wherein the case body has a through-hole that communicates with the ventilation path to enable a fastening amount to be adjusted from an outside by the adjustment member.
